(19) United States
(12) Patent Application Publication
(10) Pub. No.: US 2012/0322306 A1
(43) Pub. Date: Dec. 20, 2012

(54) ELECTRICAL CONNECTOR

(75) Inventors: Hung-Chi TAI, JHONGHE (TW); Yong-Gang ZHANG, TAICANG (CN); Kun LIU, Taicang (CN); Yi-Chang CHEN, JHONGHE (TW)

(73) Assignee: ALLTOP ELECTRONICS (SUZHOU) CO., LTD, Taicang City (CN)

(21) Appl. No.: 13/208,901

(22) Filed: Aug. 12, 2011

(30) Foreign Application Priority Data
Jun. 15, 2011 (CN) 201110160761.X

(51) Int. Cl. H01R 13/648

(52) U.S. Cl. 439/607.01

(57) ABSTRACT

An electrical connector for mating with a complementary connector includes an insulating housing, a shielding shell covering the insulating housing and a plurality of contacts received in the insulating housing. The insulating housing includes a main body and a mating tongue extending forwardly from the main body. The mating tongue defines a number of channels extending therealong. The contacts have one pair of contacts configured to be a differential coupled signal pair. The insulating housing defines one recess located between the differential coupled signal pair to improve the signal transmission performance.

### BACKGROUND OF THE INVENTION

1. Field of the Invention

The present invention relates to an electrical connector, and more particularly to an electrical connector mounted on a circuit board of an electronic device.

2. Description of Related Art

Personal computers (PC) are used with a variety of techniques for providing input and output. Universal Serial Bus (USB) is a serial bus standard to the PC architecture with a focus on computer telephony interface, consumer and productivity applications. USB can connect peripherals such as mouse devices, keyboards, PDAs, gamepads and joysticks, scanners, digital cameras, printers, external storage, networking components, etc. Under the development of technology and the need of market, to increase the transmission speed of the USB connector has become an inevitable tendency.

Therefore, a Universal Serial Bus connector with improved signal transmission speed and performance is required.

### BRIEF SUMMARY OF THE INVENTION

An electrical connector in accordance with the present invention for mating with a complementary connector includes an insulating housing, a shielding shell covering the insulating housing and a plurality of contacts received in the insulating housing. The insulating housing includes a main body and a mating tongue extending forwardly from the main body. The mating tongue defines a number of channels extending therealong. The contacts have one pair of contacts configured to be a differential coupled signal pair. The insulating housing defines one recess located between the differential coupled signal pair to improve the signal transmission performance.

### BRIEF DESCRIPTION OF THE DRAWINGS

The present invention is further described with reference to the accompanying drawings in which:

FIG. 1 is a perspective view of an electrical connector in accordance with a first embodiment of the present invention;

FIG. 2 is a perspective view of the electrical connector shown in FIG. 1 while from another aspect;

FIG. 3 is an exploded, perspective view of the electrical connector;

FIG. 4 is a perspective view of an insulating housing of the electrical connector;

FIG. 5 is a partially broken perspective view of the insulating housing;

FIG. 6 is a perspective view of a contact of the electrical connector;

FIG. 7 is a perspective view of a shielding shell of the electrical connector;

FIG. 8 is a cross-section view of a contact assembled in the insulating housing of the electrical connector; and

FIG. 9 is a perspective view of an insulating housing of the electrical connector in accordance with a second embodiment.

### DETAILED DESCRIPTION OF THE INVENTION

Reference will now be made to the drawing figures to describe the present invention in detail.

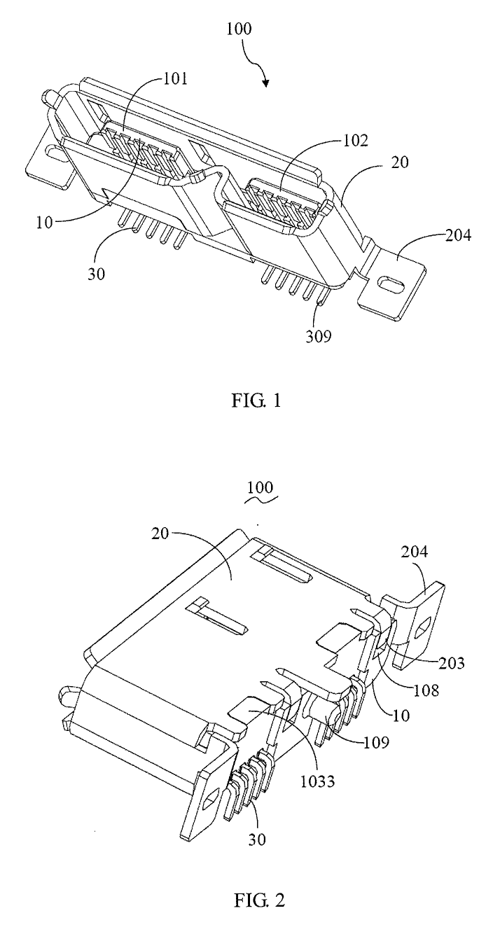

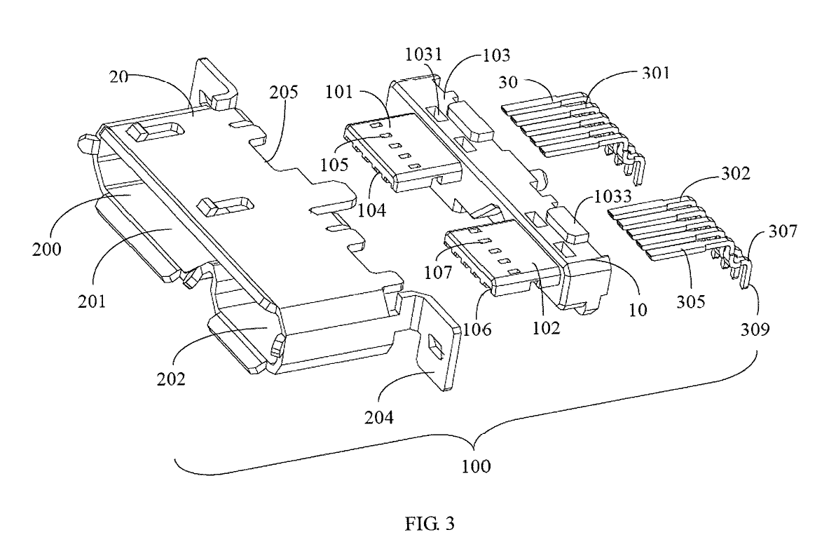

Referring to FIGS. 1-2, an electrical connector 100 in accordance with the present invention includes an insulating housing 10, a shielding shell 20 covering the insulating housing 10, and a plurality of contacts 30 received in the insulating housing 10.

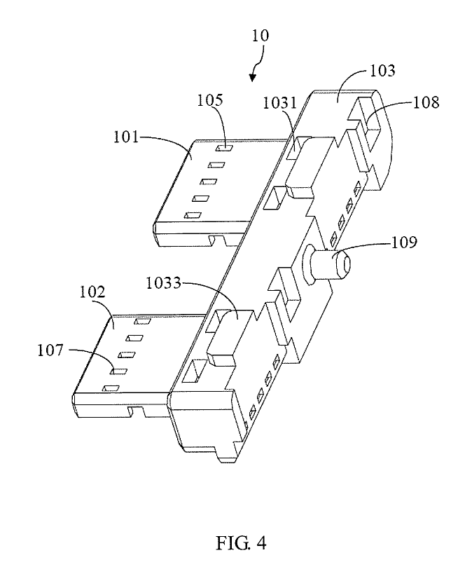

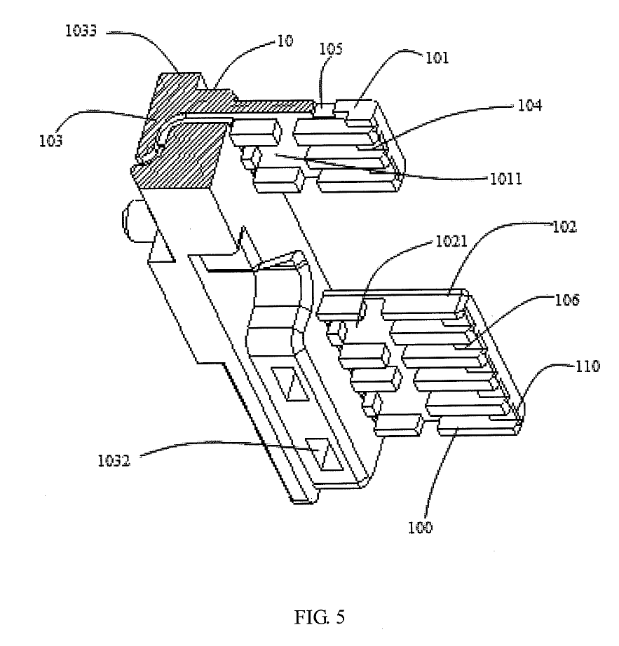

Referring to FIGS. 3-5 together with FIG. 2, the insulating housing 10 of a first embodiment is shown which includes a main body 103 and a first mating tongue 101 and a second mating tongue 102 extending forwards from the main body 103. In this first embodiment, the first mating tongue 101 and the second mating tongue 102 extends parallel along a same direction. The first mating tongue 101 defines a plurality of first channels 104 extending through a surface thereof and a first array of through holes 105 on an opposite surface. The first channels 104 communicate with corresponding first array of through holes 105. A first recesses 1011 is defined on the first mating tongue 101 and interconnecting a pair of adjacent first channels 104. In this preferred embodiment, the contacts 30 comprise a differential coupled signal pair received in corresponding first channels 104. The first recess 1011 is defined between and communicates to the two first channels 104 receiving the differential coupled signal pair. When the differential signal is transmitted by the differential coupled signal pair, the first recess 1011 can reduce the permittivity between the differential pair. As can be understood, the signal transmission with high frequency will be affected by the length, the width and the depth of the first recess 1011. Understandably, such a recess 1011 improves the signal transmission performance of the contacts 30. Similarly, in this first embodiment, the second mating tongue 102 defines a plurality of second channels 106 extending through a surface thereof and a second array of through holes 107 on an opposite surface. The second channels 106 communicate with corresponding second array of through holes 107. A second recess 1021 is defined on the second mating tongue 102 and interconnecting a pair of adjacent second channels 106. In this preferred embodiment, the contacts 30 also comprise another differential coupled signal pair received in corresponding second channels 106. The second recess 1021 is defined between and communicates to the two second channels 106 receiving the differential coupled signal pair. The first array of through holes 105 and the second array of through holes 107 are located in a direction perpendicular to an insertion direction of the complementary connector (not shown). In the preferred embodiment, the number of the through holes 105, 107 is same to the number of the contacts 30. While in other embodiments, the number of the through holes can be changed according to the applied environment. The insulating housing 10 defines a cutout 108 and a guiding post 109 along a rear side thereof. The guiding post 109 is positioned between first contacts 301 and second contacts 302 for facilitating assembly the connector 100 on an electronic device (not shown).

Referring FIGS. 3-5, the main body 103 defines a plurality of first slots 1031 and second slots 1032 on opposite upper and lower surfaces (not labeled) thereof. In the first embodiment, the first and the second slots 1031, 1032 can be communicating with each other. In other embodiment, the first and the second slots 1031, 1032 can also be blind holes. The insulating housing 10 forms a protrusion 1033 projecting from the upper surface thereof. Each first and second channel 104,106 defines a guiding portion at an entrance thereof for guiding insertion of the complementary connector.

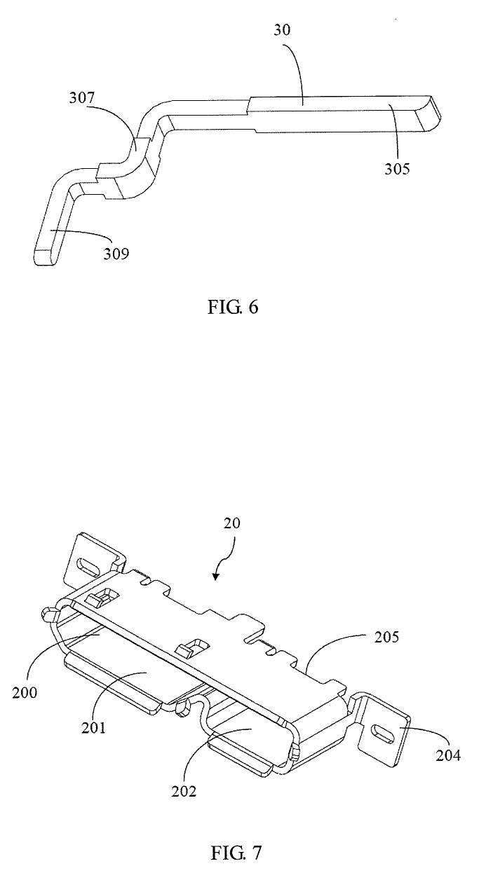

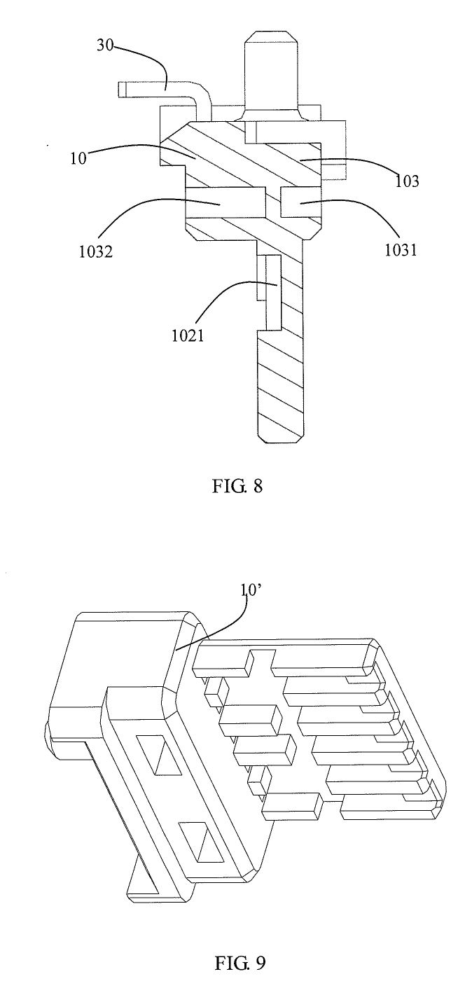

Turn to FIG. 3 and FIG. 6, the contacts 30 comprises a plurality of first contacts 301 and a plurality of second contacts 302 which are received in corresponding first channels 104 and second channels 106. As above described, both the first contacts 301 and the second contacts 302 comprises a differential coupled signal pair. Understandably, in other embodiment, the number of differential coupled signal pair can be changed according to the application environment. Each contact 30 comprises a contacting portion 305, a bent portion 307 and a fixing portion 309. When the contacts 30 are received in corresponding channels, the contacting portions 305 are partially exposed from the first through holes 105 of the first mating tongue 101 and the second through holes 107 of the second mating tongue 102. The bent portions 307 are retained in the first channels 104 and the second channels 106, respectively. The fixing portions 309 extend out of the insulating housing 10 along a direction vertical to the contacting portion 305. The fixing portion 309 is mechanically and electrically mounted to a circuit board of the electronic device. In the preferred embodiment, the configurations and the number of the first contacts 301 and the second contacts 302 are same. Additionally, both the first contacts 301 and the second contacts 302 are all meet the Universal Serial Bus interface standard. While in other embodiment, the contacts 30 can be changed to meet other types of interface standards. Especially referring to FIG. 8, the first recess 1011 and the second recess 1021 extend substantially parallel to the contacting portions 305 of the differential coupled signal pair. Consequently, the permittivity between the differential coupled signal pair is reduced and the signal transmission performance of the contacts is improved.

Referring to FIG. 7, the shielding shell 20 defines a receiving space 200 having a first receiving space 201 for receiving the first mating tongue 101 and the second receiving space 202 for receiving the second mating tongue 202. However, in the preferred embodiment, the first receiving space 201 has a different configuration from the second receiving space 202. The shielding shell 20 forms a pair of retention sections 204 at opposite rear sides thereof. The retention sections 204 are configured as a plate extending along a plane perpendicular to the insertion direction of the complementary connector for retaining the connector thereon. Turn to FIG. 2, the shielding shell 20 has a pair of retention tabs 203 extending rearwards and downwards from an upper rear edge thereof. The retention tab 203 is engaged in the cutout 108 of the insulating housing 10. The shielding shell 20 also defines a positioning cutout 205 besides the retention tab 203 for receiving the protrusion 1033 of the insulating housing 10. Understandably, the location and the structure of the retention tab 203 and the positioning cutout 205 can be changed according to the applied environment.

When the electrical connector 100 is in use, the first recess 1011 or the second recess 1021 is located between the two contacts 30 which are transmitting differential coupled signals. In the meanwhile, the contact 30 can be partially exposed from the first slot 1031 or the second slot 1032. Consequently, the noise between the neighbored contacts can be largely reduced and the signal transmitting performance is improved.

Referring to FIG. 9, the insulating housing in accordance with a second embodiment is shown. In the second embodiment, the insulating housing 10′ has only one mating tongue. While, the mating tongue of the second embodiment is same to the mating tongues of the first embodiment. Moreover, corresponding recess and slot are all same to those of the first embodiment, which are not described in more details. It should be noted that the electrical connector of the second embodiment can also improve the signal transmission performance.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for mating with a complementary connector, comprising:
an insulating housing comprising a main body and a mating tongue extending forwardly from the main body, the main body defining at least one slot, the mating tongue defining a plurality of channels extending therealong;
a plurality of contacts received in corresponding channels of the insulating housing, the contacts comprising at least one pair of contacts configured to be a differential coupled signal pair; and
a shielding shell covering the insulating housing and the contacts;
wherein the insulating housing defines at least one recess located between the at least one differential coupled signal pair;
wherein at least one contact is exposed to the air through the at least one slot of the main body.

2. The electrical connector as claimed in claim 1, wherein the mating tongue includes a first mating tongue and a second mating tongue, the first and the second mating tongues extending parallel with each other.

3. The electrical connector as claimed in claim 2, wherein the first mating tongue defines a first array of through holes and the second mating tongue defines a second array of through holes, and wherein the first array and the second array of through holes are positioned along a direction perpendicular to an inserting direction of the complementary connector.

4. The electrical connector as claimed in claim 3, wherein the contacts comprises a plurality of first contacts received in corresponding channels defined on the first mating tongue and a plurality of second contacts received in corresponding channels defined on the second mating tongue.

5. The electrical connector as claimed in claim 4, wherein each contact comprises a contacting portion, a fixing portion and a bent portion interconnecting the contacting portion and the fixing portion.

6. The electrical connector as claimed in claim 5, wherein each channel defines a guiding portion at an entrance thereof for guiding insertion of the complementary connector.

7. The electrical connector as claimed in claim 2, wherein the shielding shell defines a first receiving space for receiving the first mating tongue and a second receiving space for receiving the second mating tongue, and wherein the first receiving space and the second receiving space communicates with each other.

8. The electrical connector as claimed in claim 7, wherein the shielding shell forms a pair of retention sections at opposite rear sides thereof, and wherein the retention sections are configured as a plate extending along a plane perpendicular to the insertion direction of the complementary connector.

9. The electrical connector as claimed in claim 1, wherein the main body defines a plurality of first slots from upper face thereof and a plurality of second slots from lower face thereof.

10. The electrical connector as claimed in claim 9, wherein the insulating housing forms a protrusion projecting from the upper face thereof, and wherein the shielding shell defines a cutout receiving the protrusion.
